(19) United States
(12) Patent Application Publication
(10) Pub. No.: US 2012/0154155 A1
(43) Pub. Date: Jun. 21, 2012

(54) PERSONAL MONITORING SYSTEM

(76) Inventor: John Brasch, Lincoln, NE (US)

(21) Appl. No.: 13/257,355

(22) PCT Filed: Mar. 19, 2010
(86) PCT No.: PCT/US2010/027975

§ 371 Date: Sep. 19, 2011

Related U.S. Application Data
(60) Provisional application No. 61/163,612, filed on Mar. 26, 2009.

(51) Int. Cl. G08B 23/00

(52) U.S. Cl. 340/573.4

(57) ABSTRACT

A system for monitoring an individual includes a sensor configured to detect the presence or absence of the individual at a location. A programmable logic controller is coupled to the sensor and configured to receive a signal from the sensor indicating the presence or absence of the individual. The programmable logic controller is configured to send an alarm signal to an alarm generating device if the individual is absent from the location at a first preset time, if the individual is present in the location at a second preset time, or if the individual is absent from the location for more than a selected interval of time between the first preset time and the second preset time. A user may place the system in a standby mode to prevent an alarm signal from being sent.

### FIELD OF THE INVENTION

The various embodiments disclosed herein relate to a personal status monitoring system. In particular, the embodiments relate to a status monitoring system that is configured to sense various indications of the well-being of a person, including the presence and/or absence of a monitored person in relation to a location, and communicate meaningful change of status to an attendant and/or record keeping system.

### BACKGROUND OF THE INVENTION

Patient monitoring systems have been used to determine if a monitored person has left a bed, or is not present in a location where they should be. However, many of these systems lack the added capability and flexibility to be useful with monitored persons at varying levels of self-sufficiency either in a home or institutional setting. They also tend to monitor only one indication of personal status, not multiple indicators, and do not have the ability to integrate and interpret multiple status conditions that can, in the aggregate, indicate a need for attendant intervention.

Accordingly, there is a need for an improved personal status monitoring system.

### BRIEF SUMMARY OF THE INVENTION

One embodiment disclosed herein relates to a system for monitoring an individual includes a sensor configured to detect the presence or absence of the individual at a location. A programmable logic controller is coupled to the sensor and configured to receive a signal from the sensor indicating the presence or absence of the individual at a predetermined time or time interval. The programmable logic controller, or the monitor, may be configured to send an alarm signal to an alarm generating device if the individual is absent from the location at a first preset time, if the individual is present in the location at a second preset time, or if the individual is absent from the location for more than a selected interval of time between the first preset time and the second preset time or at a predefined time of day. Further the logic controller may be configured to recognize frequency of movement and durations of movement activity. The programmable logic controller may further be configured to report changes in status to a record keeping device such as a computer. A user, such as the monitored person or care giver, may place the system in a standby mode to prevent an alarm signal from being sent.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a perspective view of a personal monitoring system placed in a bedroom, according to one embodiment.

FIG. 2 is a perspective view of a personal monitoring system, according to one embodiment.

FIG. 3 is a perspective view of a remote transceiver, according to one embodiment.

FIG. 4 is a schematic view of a controller logic, according to one embodiment.

FIG. 5 is a schematic view of a controller logic, according to one embodiment.

FIG. 6 is a schematic view of a controller logic, according to one embodiment.

### DETAILED DESCRIPTION

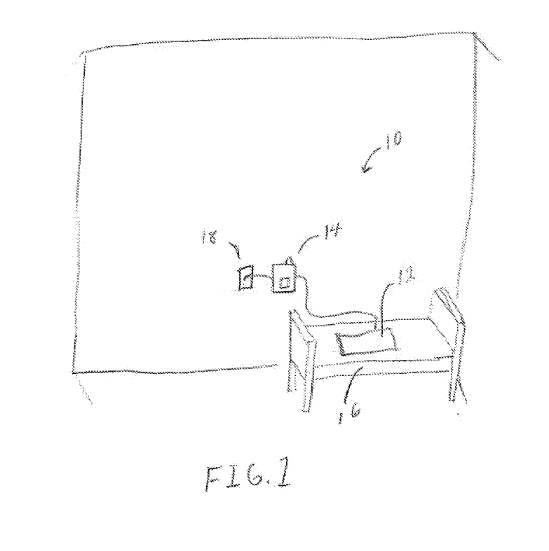

Referring to FIG. 1, a system 10 for monitoring a person includes a sensor 12 and a monitor 14. In this embodiment, sensor 12 is shown as a pressure sensitive pad coupled to monitor 14 by a wire. Alternatively, sensor 12 may be an infrared sensor, a strain gauge, or any other known sensor suitable for detecting the presence or absence of a person on the bed. Sensor 12 may be configured to either transmit a signal to monitor 14 when an individual is present or absent. In either scenario, it is the change in the signal that is interpreted by monitor 14.

According to alternative embodiments, for purposes of rape or abuse prevention, the sensor 12 can also be configured to transmit a signal to the monitor 14 when sufficient additional weight is placed on the bed to indicate that another person may be in the bed with the person being monitored. In such embodiments, the sensor 12 can be a variable resistance pad or a strain gauge that indicates a change in the weight on the bed. In one embodiment, the sensor 12 can be configured to transmit a signal to monitor 14 upon the occurrence of an increase in weight on the bed of greater than some pre-determined amount. For example, the sensor 12 could be configured to transmit a signal to the monitor 14 when there is an increase in weight of 50 pounds or more. Alternatively, the predetermined weight increase could be set to any amount. In accordance with certain embodiments, the predetermined amount of the weight increase should be large enough so that normal usage of the bed such as temporarily placing objects such as personal or medical items on the bed would not trigger a signal to the monitor 14.

It should be noted, that while the system is shown in use with a bed, the system 10 may be used with a chair, or for a person standing, sitting, reclining or lying on a floor, on a stretcher, operating table, or exam table. Further, in addition to indicating the presence or absence of an individual and/or indicating if another individual may be in the bed with the person being monitored, the sensor 12, or another sensor, may be used to monitor biometric indicators such as body temperature, heartbeat, respiration, recent movement (repositioning), enuresis, and restlessness to alert the attendant if the monitored person may be in a compromised status and/or has not moved for an extended period. The system may be configured to do this biometric monitoring in combination with monitoring the person's status with respect to being in or out of bed and/or whether another person is in the bed with the person being monitored. Monitor 14 may be linked to a data network, phone line, computer, or other device through link 18.

Referring to FIG. 2, monitor 14 is coupled to sensor 12 by a wire 20 or wireless connection. An external power supply 22 may be used to power monitor 14 using wires 24. An internal power supply 26 may also be provided and may include a battery or batteries configured as a backup power supply in the event the external power supply 22 fails or is disconnected from monitor 14. Monitor 14 may also include a button 28, a visual indicator 30, an audio indicator 32, a data output 34, and a display 36. In some embodiments, an IR reader that works with the IR reset fob may be provided. A switch may be provided in the battery compartment to allow a caregiver to turn off an external reset button (28). When button 28 is disabled only a remote reset fob can reset monitor 14 thus eliminating potential for unauthorized reset of the alarm signal).

As discussed above, the sensor 12 in any of the embodiments disclosed herein can be a pressure sensitive pad, an infrared sensor, a strain gauge, or any other known sensor suitable for detecting the presence or absence of a person on the bed or further suitable for detecting a predetermined weight change or detecting other types of biometric parameters as described above. According to certain embodiments in which the sensor 12 is a pressure sensitive pad, the pad covers substantially all of the mattress of the bed on which the pad is positioned. Alternatively, the pad covers at least a portion of the bed. In various other embodiments in which the senor 12 is a strain gauge, the gauge can be positioned on one or more of the legs of the bed. In one specific embodiment, there is a separate strain gauge positioned on each of the four legs of the bed. Alternatively, one or more strain gauges can be positioned over the mattress, under the mattress, or any other known position associated with the bed from which the strain gauge can detect load bearing changes on the bed.

Button 28 may be a push button, touch sensor, or other device configured to receive an input from a user proximate to monitor 14. Visual indicator 30 may be an LED or other light source. Audio indicator 32 is shown as a speaker housed within monitor 14, but may be any suitable audio device. Data output 34 may be any suitable electronic link, such as a phone jack (i.e. a RJ11, BS 6312, or other port), Ethernet port (i.e. an RJ45 port), or other suitable port. In some embodiments, a wireless transceiver may be used in place of, or in addition to, data output 34. Display 36 may be an LCD, LED, or other suitable display, and in some embodiments, display 36 may be used to indicate the present time. Button 28 may be actuated when a monitored person leaves bed to reset the system before monitor goes into a delay cycle leading to an alarm. According to one embodiment, the button 28 allows for variable extension of the delay cycle. That is, the button 28 in certain embodiments can provide for additional extension of the delay cycle by depressing the button 28 more than once. For example, if a user depresses the button 28 three times, then the delay cycle runs three times before sounding the alarm. In this fashion, a user or coherent monitored person could set the amount of the delay based on her or his needs. The same button is used to reset the monitor when it goes into alarm.

In a further implementation, the amount of time in the delay cycle can be customized or programmed at the monitor or remotely (through a network such as the Internet, for example, or some other form of remote access) to meet the needs of the particular monitored person.

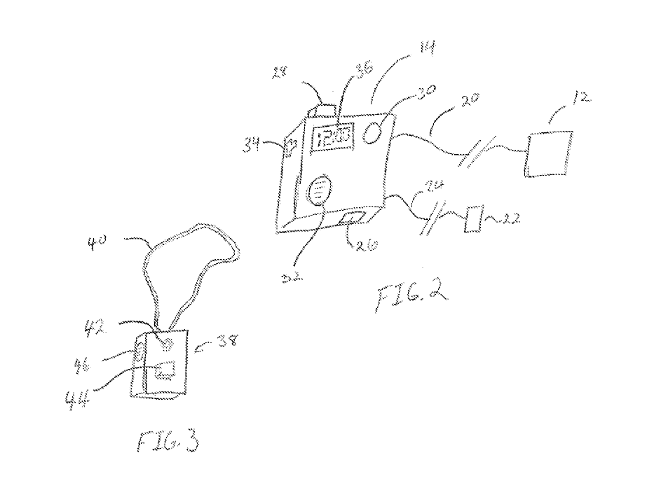

Referring to FIG. 3, a remote transceiver 38 may include a cord 40, an indicator 42, an actuator 44, and an audio indicator 46. Cord 40 may be provided a sufficient length to allow transceiver 38 to be worn by a person. Alternatively, cord 40 may be replaced or used in conjunction with belt clip, armband, waist belt, or leg band. In some embodiments, indicator 42 may be an LED that illuminates when transceiver 38 receives a signal from monitor 14. In addition, audio indicator 46 may be simultaneously activated with indicator 42, or indicator 42 and audio indicator 46 may be activated in sequence. Actuator 44 may be a push button that may be used to send a reply signal back to monitor 14. Monitor 14 may then send a verbal or other audio or other audio file message that the alert had been received thus providing reassurances that the alert has been activated to the person presumed to be in distress.

Having described the primary components of the system, attention is now given to the method of the system's operation. A timing system 10 may be used to detect when a person has left a bed or chair, has not left a bed or chair and/or has not returned to a bed or chair. System 10 may be used to detect when an individual has not returned to bed or chair during a bathroom visit in the night or some other event. In a different mode, system 10 may detect when a person is incapacitated to the extent that they did not leave their bed at a prescribed time in the morning, during a preprogrammed period of time or time interval or other time of significance to an attending care giver. According to another mode, the system 10 can be used as a rape or abuse prevention device to detect when another individual is in the same bed as the person being monitored, such as an at-risk resident at a nursing home or other type of institution.

In some embodiments, an “attending” caregiver (such as a spouse) may be awakened by an alert if a monitored person has not returned to bed after a bathroom visit or other acceptable hiatus, or lack thereof. Also, a parent of a sleepwalking child could be alerted if the child has not returned to bed in the middle of the night after a short interval. In a nursing home setting, a nurse will be alerted if a patent has not returned to bed after a normal interval.

In other embodiments, the system may be capable of remote monitoring of change of status or change in the frequency and/or duration of movement. In such embodiments, an attending family member living some distance away may be alerted if their parent has not returned to bed after a normal night interval, or has not arisen in the morning by an expected time. Additionally, the system may monitor demented or mentally ill patients who may wander and need to be observed if not promptly back. The system may monitor livestock and/or a companion animal. The system may monitor cognitively challenged people, the mentally ill, children, and persons within the judicial and/or correctional system (e.g., house arrest, subject to a restraining order). The system may also be used to monitor employees at a worksite or customers at a defined location such as in front of a display in a retail store using timing sequence and direction to differentiate between one person and another. The system may be used to monitor occupancy in seats in a theatre, a classroom or a transportive vehicle such as a plane, train or automobile. It may be used by a person supervising a time out of a child. Alternatively, the system may be made compatible with unique ID radio frequency devices or capable of measuring biometrics of individuals to identify them.

For use with animals, a sensor may be placed in or near a pen for a livestock animal. The sensor may be configured to detect the presence and/or absence of the animal from the pen and be coupled to a monitor. This system would allow a person to remotely monitor the animals in the person's care. Additionally, a plurality of sensors could be used throughout a facility or home to determine the presence and/or absence of a companion animal. In such a system, the sensors could be coupled to a monitor and the system may be configured to send a SMS/text message, e-mail, or other alert to a remotely located animal owner or other person in the event a companion animal is no longer detected inside the home, yard, or facility.

The system may also be used in a correctional or other facility to monitor the location of inmates. In such an application, it may be advantageous to surreptitiously position a sensor within a cell, interrogation room, or other holding room to monitor the presence or absence of a subject in the room, or the frequency and/or duration of subjects being present at a location. The use of additional biometric monitors could result in a more certain identification of the person being monitored. Similarly, such a system could be used to monitor persons confined to their homes or otherwise subject to curfews or other restrictions. Such persons could be provided with a secured unique identifier (such as an RFID chip) that is detected by the sensor, to monitor a specific individual.

Where two or more persons are being monitored with respect to location, the location of one person proximate to another (or others), or proximate to a location of interest could be programmed to cause an alarm, as may be appropriate to security in a care facility.

Further the frequency and duration of monitored co-location could be measured and alerts sense as appropriate to an algorithm. Such multiple personal monitoring could be timed to occur at certain times of the day for different people.

For example, the system may be used by at least one individual in a home care situation where the “care provider” (a spouse, adult child of elderly parent, parent of subject child, nurse or other person concerned for the safety of the monitored person) is sleeping, or at a remote location. It is expected that this device will also be used in residential homes, hospitals, nursing homes, assisted living facilities, and elderly housing and in related applications where knowledge of the well being of an individual is needed by a care provider.

In an optional configuration, the unit may send data in such a way as to provide an event driven record of activities being monitored, for instance, when a person leaves bed, when they return, and in some configurations the frequency and duration of such activity. In another configuration the system would learn routines natural to the person being monitored and either suggest cautionary scenarios or take a programmed decision based on a flow of data that suggests that abnormal behaviors are evident. (Fuzzy Logic).

Monitor 14 may use a programmable logic controller with a timer and an LED clock face display. This system may be easy to set and would work in some ways like an alarm clock. In other embodiments, a second device could be coupled to monitor 14 through data link 34. The second device could then be used to program the system. In yet another embodiment, monitor 14 may be coupled to a network through data link 34 to allow a user to program the system from a remote location over a network. In some such embodiments, the network may be the Internet or a local area network (LAN). A third party monitoring company may be used to program the system, or a caregiver may be provided with a web-based or other such portal with which to program the system. To prevent accidental deactivation of the system by a monitored person, monitor 14 may not have an on/off switch. Instead, the system may be activated automatically when sensor 12 detects the presence of the monitored person. The system may also include a “nurse call” output either through data link 34, or through another port. When the system alarms, the nurse call output may be continuous rather than intermittent.

The timer of the system may be set for one or a set of fixed periods of time or a variable period of time, alerting a care provider of a possible fall, incapacitation or other condition requiring assistance. Monitor 14 detects the leaving of a bed or chair via a signal from sensor 12, activates a timer, and at a predetermined interval activates a local alert and/or a remote alert by way of a wired or wireless link (i.e. IR, RF, or other wireless link) to a receiving unit. The receiver activates an alarm signal. The alarm signal may comprise a sound such as a beeper, buzzer or siren, or other alerting mechanism such as a vibrator or light to alert a care provider of a “non return” event or other event concerning presence, absence or status of the monitored person. The alarm signal may comprise an automated telephone call, a short messaging system (SMS) text message, and/or activation of a radio pager or other remote sounding or indicating device. The detecting apparatus may also be connected to an existing nurse call system or to a telephone auto dial alert with a preprogrammed voice message specific to the non return.

In accordance with one embodiment, the system may operate in one mode by sounding an alarm if the person is away from bed too long during a certain time interval (“AWAY TOO LONG” Mode) (e.g., person is out of bed more than 15 minutes between 11 pm and 7 am). A user, such as a caregiver, may be able to set both the Delay Interval (amount of time monitored person is allowed to be away from bed) and the time period during the day when this mode is enabled. For example, the user can set the enabled time period to begin at 10 pm and end at 7 am, such that the alarm sounds if the monitored person is absent from the bed for longer than the Delay Interval during that period, but the mode is not enabled between 7 am and 10 pm such that the alarm does NOT sound when the monitored person gets out of bed after 7 am with no plans to return until that evening. When used in the AWAY TOO LONG Mode, the timer may begin counting down when the person is no longer detected by the sensor and then goes into an alarm if the person has not returned to the sensor by the time the Delay Interval expires. If the monitored person returns to the sensor before the delay interval expires a signal of the return may be sent to the monitor then the monitor resets to active monitoring and the timer resets back to zero ready for the next departure. The monitor begins the count down from the beginning if the person leaves the sensor again.

According to another implementation, when used in an “IN BED” Mode, a user may set a time of day on the monitor at which the status of the sensor is checked. If the sensor is activated at this time (i.e., the subject person is in bed), then the system sends an alarm signal. For example, in this mode, the time of day may be set for 8 am on the monitor and the system sends an alarm signal if the subject person is in bed at 8:00 AM. In this example, the user is setting the time of day the monitor checks to see if the bed is occupied. In another embodiment the monitor may be programmed for multiple times during the day. In some of these embodiments, the logic controller may be programmed such that an exit from bed after a set time (e.g. 6:00 AM) would result in an alarm. This would provide the monitored person with a window of between 6:00 and 8:00 AM during which the monitored person could rise for the day and not trigger an alarm.

In another embodiment, when used in an “OUT OF BED” Mode, a user may set the time of day on the monitor at which the system sends an alarm signal if the sensor is not activated (i.e., if a subject person is not detected by the sensor at that time). Again, in another embodiment multiple times can be set to report if the sensor is not activated (if sensor does not detect the monitored person) at a preprogrammed time. In yet other embodiments, the system could sense an “out of bed” signal and a return to bed reset to confirm a normal nocturnal absence from bed during a predetermined time period.

According to a further implementation, when used in an “ABUSE PREVENTION” mode, the system can sound an alarm if the weight on the bed increases by an amount that indicates that it is likely that another individual is in the bed with the person being monitored. A user, such as a caregiver, may be able to set the amount of weight increase that must occur in order for the signal to be sent. In one embodiment, the monitor can be programmed to shut off the alarm as soon as the amount of weight on the bed drops back to the amount prior to the increase. Alternatively, the monitor can be programmed to continue to sound the alarm for some amount of time regardless of whether the amount of weight returns to its original amount. In an alternative embodiment, there may be circumstances in which it may be expected that a caregiver may be sitting on the bed providing care to the person being monitored. In such circumstances, the monitor may have a timer that is set to a predetermined amount of time that must pass before an alarm is sounded. As such, the weight may increase by the predetermined amount such that the sensor transmits a signal to the monitor, and the monitor begins a timer that runs for the predetermined amount of time before the alarm is sounded.

The monitor may also be used as a conventional bed monitor to sound an alarm immediately when the monitored person leaves the bed by setting the Delay Interval to one or two seconds when monitor is in the AWAY TO LONG Mode.

In another embodiment, the system can also include one or more additional sensors positioned at one or more additional locations away from the bed that can be used to trigger an alarm if the monitored person remains in single location for too long, potentially indicating that the person has fallen and is not able to move. For example, an additional sensor such as a pressure sensitive pad or an infrared sensor can be positioned in the bathroom. Alternatively, the sensor can be positioned along a pathway to the bathroom. In a further embodiment, multiple sensors are positioned along the pathway to the bathroom and in the bathroom. The sensor (or sensors) can, in one implementation, be coupled to the same monitor as the sensor located in the bed or it can be coupled to the monitor of a second, separate system. In either embodiment, when the monitored person steps onto the sensor, the sensor transmits a signal to the monitor, thereby triggering a timer set to a predetermined amount of time. If the monitored person remains on the sensor longer than the predetermined amount of time, the sensor transmits a signal to the monitor that triggers an alarm.

Alternatively, various systems could also include one or more additional sensors positioned at one or more additional locations away from the bed that can be used to reset a timer, such as the timer in the AWAY TOO LONG mode. For example, in one embodiment, sensors can be positioned on a refrigerator or a toilet such that if the monitored person triggers either of the sensors, the timer that was activated when the person exited the bed would be reset (the timer would re-start its countdown), thereby allowing the monitored person more time to return to the bed before the alarm is triggered. Generally, the idea is that a monitored person may have left the bed and may be away from the bed so long that the alarm is triggered (or about to be triggered), and yet the person may not be in danger or be experiencing difficulties and instead may be involved in some other activity such as using the toilet, obtaining food or beverages from the fridge, or any other such activity that might keep the person from the bed longer than the time allotted by the timer. Other non-limiting examples of sensor locations could be a kitchen entrance, a bathroom entrance, or a chair or other seat in a TV viewing area.

As mentioned above, various systems can include two or more monitors working separately or in cooperation according to any of the embodiments disclosed herein. The monitors may be configured to be in communication with each other via a cord or other known physical coupling, or, alternatively, via a network (such as, for example, the Internet). In some implementations in which the two or more monitors are coupled to the Internet, each of the monitors can have its own separate IP address.

The monitor may operate in more than one mode at the same time. For example, the monitor may send an alarm signal both if subject person was not in bed at first designated time (e.g. 10:00 PM) or not out of bed at designated time (e.g. 8:00 AM).

In some embodiments, the unit may have a silent alarm option so that the local alarm on the monitor can be turned off but the monitor still activates an alarm output, such as an alarm signal to a nurse call station, at which an audible and/or visual alarm is output. In at least one embodiment, this silent alarm option is selected by a user. The user may turn on or off the silent alarm option if the user wanted the local alarm and nurse call output or just nurse call output alone. In addition to a nurse call station, the alarm signal may be communicated to any other device capable of receiving the alarm signal. For example, the silent alarm option may send an alarm signal to a smart phone, a personal digital assistant (PDA), a remote audible output device, a radio pager. The alarm signal may be conveyed via the Internet, a local area network (LAN), a wide area network (WAN), SMS text message, wireless communication protocol (e.g., 802.11x, Bluetooth, infrared), telephone line, cellular telephone network, or a combination thereof.

In a further embodiment, the silent alarm option may only be activated when the monitor is operatively connected to the non-local alarm output (e.g., nurse call output) (“failsafe” feature). This failsafe feature operates so that if nothing is operatively connected to the non-local alarm output (e.g., the nurse call output port) on the monitor, the monitor will sound a local alarm even if the switch is set to silent mode.

Additionally, the monitor may have a pre-alert feature which a user can turn on or off. This pre-alert feature sounds an audible and or visible local alarm from the monitor before the alarm output port on the monitor is activated. This allows a cognitively aware monitored person to disable or pause the system before a nurse call or other signal is sent to a third party. The interval between local alarm emitted by the monitor and the activation of the alarm output port may be able to be set by user or preset at the factory. In addition, the local alarm emitted by the monitor may also be indicated on the wireless remote sounder such as transceiver 38. This indication may be separate and distinct from the full alarm on the remote sounder. The monitored person or caregiver could then pause or reset the system by actuating transceiver 38 to send a reply signal to monitor 14. In some situations or locations, it may be useful to use a repeater as an accessory to extend the range of transceiver 38. In some embodiments, a switch may be provided in internal power supply 26 (i.e. a battery compartment) of the monitor which allows user to disable the reset/standby (button 28) so that only the transceiver can be used to reset or bypass the monitor. In addition to transceiver 38, a reset fob may be used to transmit a signal which is used only to reset the monitor.

In one alternative implementation, the pre-alert feature described above can be scheduled for a particular period of the day. For example, the monitor could be programmed to trigger a pre-alert during the time period from 7 a.m. to 9 a.m. to remind the monitored person that the AWAY TOO LONG mode is active, thereby providing an opportunity for the monitored person to deactivate that mode when they get out of bed for the day by either pressing the “off” button or a “reset” button or any other type of deactivation button. The pre-alert could be a recorded voice reminder, an audible alarm, a flashing light, or any other known type of alert.

In some embodiments, the monitor may have a status indicator light (awareness feature) (i.e. indicator 30). This light could be configured to blink rapidly for a few seconds or longer (continuously) when the monitored person first gets out of bed. It may also blink intermittently while the unit is in the countdown mode to alarm. When the monitored person is in bed this light may not blink at all, or blinks at intervals of >0.5 of the base frequency. The monitor may also be provided with a low battery alert so that the monitor chirps when the battery is going dead. The nurse call output may optionally be activated when the unit is in low battery alert.

Alternatively, the status indicator light could be a bright directed light that lights a large area around the bed, a large area of the room containing the bed, or a path toward the bathroom or other area. In this embodiment, the light illuminates when the monitored person first gets out of bed and remains lit until the monitored person returns. In a further alternative, the light could begin to flash or blink intermittently while the unit is in countdown mode to alarm.

In some embodiments, a flashing strobe light that could be utilized with monitor 14 by being plugged into the nurse call output or data link on monitor 14 and activated when the system is in alarm. In other embodiments, an optional device may plug into monitor 14 so that a bedside lamp or other appliance could be turned on when the monitored person leaves the bed.

The system may use multiple modes at the same time so that same monitor would alarm if person was not in bed at first preset time, not out of bed at second preset time or away from bed for too long during a designated interval. A user should be able to program the monitor so it can operate in these modes at the same time or independently of each other. In some embodiments, the activation period for the “Away Too Long” mode may be different than the time settings used from the “In Bed” or “Out of Bed” modes.

In the event that system 10 goes into alarm, or pre-alert, a user (either the monitored person or caregiver) may place the system in standby by actuating button 28 on monitor 14, or actuator 44 on transceiver 38. Alternatively, actuation of one or more of the button 28 or actuator 44 may result in “timing out” the system for a preset amount of time (i.e. 15 minutes. The system would then delay the alarm for the preset amount of time. For a cognitively aware monitored person there may be times that they do not expect to quickly return to bed. For instance, they may want to read for a while. For them the switch is a way to put the system on standby. The caregiver is not the one activating the switch. It is the monitored person who is using a standby feature. The system automatically resets when the monitored person returns to bed. If the standby feature (e.g. button 28) is disabled because the monitored person should not use it, then transceiver 38 may become an alternative way to put the system in standby mode. In some embodiments, actuating button 28 may place system 10 in a standby mode until the monitored person returns to bed. In other embodiments, actuation of button 28 may only place system 10 in a standby mode for a preset amount of time. Additionally, system 10 may be configured such that each actuation of button 28 adds a measure of time to the total length of time the system will be in standby mode. For example, system 10 may be configured so that each actuation of button 28 places the system in standby mode for tem minutes. In such a situation, a user may actuate button 28 three times in short succession to place system 10 in standby mode for a total of thirty minutes.

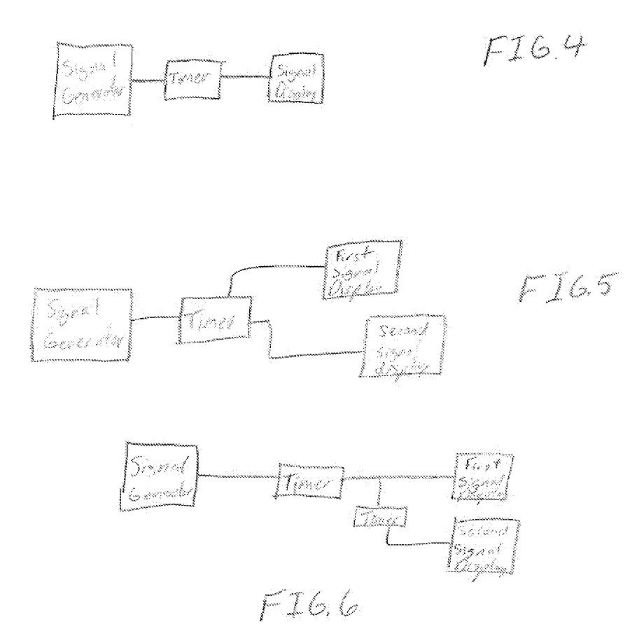

Referring to FIG. 4, a controller logic includes a signal generator, a timer and a signal display. In this controller logic, there is no pre-alert present. Rather, the signal generator (e.g. a sensor) transmits a signal that activates a timer. The timer may be housed in monitor 14 of system 10 shown in FIGS. 1 and 2. Once the timer has received a signal from the signal generator, a preset amount of time may elapse before the timer sends a signal to a signal display. The display may be audible or visual, and the signal may be displayed locally or remotely. The timer may operate on one or more logics depending on a preset program. For example, in an “AWAY TOO LONG” mode, the timer may receive a signal (or stop receiving a previously continuous signal) from the signal generator (e.g. a sensor). The timer would then begin a count down for a preset time interval. After the end of the time interval, a signal would be sent to the signal display to summon assistance or issue an alarm. In an “IN BED” Mode, the timer would not countdown. Rather, if the monitored person is detected in bed, the signal is immediately passed on to the signal display at the designated time of day or night. Similarly in the “OUT OF BED” mode, the timer does not countdown, but immediately passes a signal to the signal display if no monitored person is detected in the bed at the designated time of day or night.

Referring to FIG. 5, a single timer is used to operate with a pre-alert. In this logic, the timer begins running with the reception or cessation of a signal from the signal generator. Once a first time has elapsed, a signal is sent to a first signal display to display the pre-alert. Once the timer reaches a second elapsed time, without interruption, a second signal is sent to a second signal display which is the full alarm mode.

Referring to FIG. 6, a dual-timer logic is used to provide a pre-alert. The first timer begins running with the reception or cessation of a signal from the signal generator. Once a first preset amount of time has elapsed, the first timer passes a signal to a first signal display to generate the pre-alert. A second timer is in parallel with the first signal generator and begins running roughly simultaneously with the pre-alert. Once a second preset amount of time elapses, the second timer passes a signal to the second signal generator which places the system in full alarm.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

Although the present invention has been described with reference to preferred embodiments, persons skilled in the art will recognize that changes may be made in form and detail without departing from the spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A system for monitoring an individual comprising:
a logic system;
a first sensor in communication with the logic system for sensing a condition of the individual and providing a first signal to the logic system;
at least a second sensor in communication with the logic system for sensing if the individual is present in a location at one of a first preset time or at a second preset time, or if the individual is absent form the location for more than a selected interval of time between the first preset time and the second preset time or at a predefined time of day or if there has been a predetermined frequency of movement of the individual or a predetermined durations of movement activity and providing a second signal;
an indicating system for providing an indication representative of the condition of the individual.

29. A system in accordance with claim 28 further including a record keeping device wherein changes in status of the individual are recorded by the logic system.

30. A system in accordance with claim 29 wherein the logic system permits a user such as the individual or care giver to place the system in a standby mode to prevent an alarm signal from being sent.

31. A system in accordance with claim 28 wherein the first sensor senses the presence or absence of the individual at a first location.

32. A system in accordance with claim 28 in which the logic system is a programmable logic system coupled to the first sensor and configured to receive a signal from the first sensor and from another source wherein the combination of the first sensor and the signal from the another source provides an indication of the individual's condition.

33. A system in accordance with claim 28 wherein the first signal is generated in response to the presence or absence of the individual and the second signal is generated by a timer.

34. A system in accordance with claim 28 wherein the location is a bed.

35. A system in accordance with claim 28 wherein the logic system is a computer controller and the provided indication is a text message or a prerecorded phone call.

36. A system in accordance with claim 28 wherein the indication may be terminated remotely.

37. A method of monitoring a patient comprising the steps of:
sensing the presence of the patient at a first location to provide a first biometric condition and generating a first signal;
sensing at least one other biometric condition of the patient and generating a second signal;
utilizing the first signal and the second signal to generate an indication of the condition of the patient.

38. The method of claim 37 wherein the indication is an alarm signal.
